(19) United States
(12) Patent Application Publication
(10) Pub. No.: US 2025/0007213 A1
(43) Pub. Date: Jan. 2, 2025

(54) CONNECTOR AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Thomas CRUBLE, Mie (JP)

(21) Appl. No.: 18/694,944

(22) PCT Filed: Sep. 26, 2022
(86) PCT No.: PCT/JP2022/035747

§ 371 Date: Mar. 22, 2024

(30) Foreign Application Priority Data
Sep. 30, 2021 (JP) 2021-161413

(51) Int. Cl. H01R 13/629; H01R 13/639

(52) U.S. Cl. CPC H01R 13/62938; H01R 13/62944; H01R 13/62955; H01R 13/639; H01R 2201/26

(57) ABSTRACT

A connector includes a connector housing, a lever that is movable relative to the connector housing along a first axis from a first position to a second position, and a lock member that is movable relative to the connector housing from a third position to a fourth position. The connector housing is configured to approach a state of fit to the counterpart housing as the lever moves from the first position to the second position. The lock member regulates a movement of the lever by making contact with the lever located at the second position in a state in which the lock member is located at the fourth position, and the lock member is covered with a lever in a state in which the lever is located at the first position or is exposed from the lever in a state in which the lever is located at the second position.

### TECHNICAL FIELD

The present disclosure relates to a connector and a connector assembly.

### BACKGROUND

Conventionally, vehicles such as a hybrid car and an electric car are provided with onboard equipment including a high pressure battery and an inverter. Onboard equipment is connected to another via a wire harness and a connector assembly. A connector assembly includes a counterpart connector and a connector that can be connected to the counterpart connector by a relative movement in a first direction along a first axis. The counterpart connector includes a counterpart terminal and a counterpart housing. The connector includes a terminal electrically connectable to the counterpart terminal and a connector housing that can be fit to the counterpart housing. Such a connector thus includes a lock member for keeping a fit state in which a connector housing is fit onto a counterpart housing (for example, see Patent Document 1). Specifically, the counterpart housing has a protrusion extending in a direction crossing the first axis, and the connector housing has an engaging portion that is so flexible as to engage with the protrusion. When the lock member is slid to a locking position along the first axis relative to the connector housing in a fit state in which the connector housing is fit onto the counterpart housing, the lock member keeps the engagement between the protrusion and the engaging portion by suppressing deformation of the engaging portion. The connector configured thus can suppress easy disengagement caused by, for example, external forces such as vibrations. Moreover, in a state in which the connector housing is not fit onto the counterpart housing, a movement of the lock member from an unlocking position to the locking position is regulated by engagement with the engaging portion, thereby suppressing wrong operations. In a state in which the connector housing is fit onto the counterpart housing, the lock member is lifted to a position where the lock member is not engaged with the engaging portion by the counterpart housing, so that a movement of the lock member from the unlocking position to the locking position is permitted.

### PRIOR ART DOCUMENT

### Patent Document

Patent Document 1: JP 2020-145191 A

### SUMMARY OF THE INVENTION

### Problems to be Solved

However, the connector assembly is configured to suppress wrong operations by engaging the lock member with the engaging portion. Thus, if an operation is performed by a large force, deformation or the like may lead to a wrong operation. Furthermore, the placement of the lock member at the locking position without fitting the connector housing onto the counterpart housing may cause problems, for example, the connector housing cannot be fit onto the counterpart housing.

The present disclosure has been devised to solve the problem. An object of the present disclosure is to provide a connector and a connector assembly that are capable of suppressing wrong operations of a lock member.

### Means to Solve the Problem

A connector according to the present disclosure is a connector connectable to a counterpart connector by a relative movement in a first direction along a first axis, the counterpart connector including a counterpart terminal and a counterpart housing, the connector including: a terminal connectable to the counterpart terminal; a connector housing that accommodates the terminal and is allowed to be fit onto the counterpart housing; a lever that is mounted on the connector housing and is movable relative to the connector housing along the first axis in a range from a first position to a second position ahead of the first position in the first direction; and a lock member that is mounted on the connector housing and is movable relative to the connector housing in a range from a third position to a fourth position, wherein the connector housing is configured to approach a state of fit to the counterpart housing as the lever moves from the first position to the second position, the lock member regulates a movement of the lever by making contact with the lever located at the second position in a state in which the lock member is located at the fourth position, and the lock member is covered with the lever in a state in which the lever is located at the first position or is exposed from the lever in a state in which the lever is located at the second position.

A connector assembly according to the present disclosure includes the connector and the counterpart connector.

### Effect of the Invention

According to the connector and the connector assembly of the present disclosure, a wrong operation of the lock member can be suppressed.

### BRIEF DESCRIPTION OF THE DRAWINGS

FIG. 1 is an exploded perspective view illustrating a connector assembly according to an embodiment.

FIG. 2 is an exploded perspective view illustrating a connector according to the embodiment.

FIG. 3 is a plan view illustrating a connector housing and an arm according to the embodiment.

FIG. 4 is a plan view illustrating an initial fit state of the connector assembly according to the embodiment.

FIG. 5 is a plan view illustrating a fit state of the connector assembly according to the embodiment.

FIG. 6 is a perspective view illustrating a mounting portion according to the embodiment.

FIG. 7 is a side view illustrating the mounting portion according to the embodiment.

FIG. 8 is a perspective view illustrating a lock member according to the embodiment.

FIG. 9 is a cross-sectional view illustrating the mounting portion and the lock member according to the embodiment.

FIG. 10 is a cross-sectional view illustrating the mounting portion and the lock member according to the embodiment.

FIG. 11 is a cross-sectional view illustrating the mounting portion and the lock member according to the embodiment.

FIG. 12 is a partial perspective view illustrating the connector assembly according to the embodiment.

FIG. 13 is a partial perspective view illustrating the connector assembly according to the embodiment.

FIG. 14 is a partial cross-sectional view illustrating the connector according to the embodiment.

FIG. 15 is a partial front view illustrating the connector according to the embodiment.

FIG. 16 is a perspective view illustrating an arm according to the embodiment.

FIG. 17 is a partial cross-sectional view illustrating the connector assembly according to the embodiment.

FIG. 18 is a partial cross-sectional view illustrating the connector assembly according to the embodiment.

### DETAILED DESCRIPTION TO EXECUTE THE INVENTION

### Description of Embodiment of Present Disclosure

An embodiment of the present disclosure will be first described in list form.

[1] A connector according to the present disclosure is a connector connectable to a counterpart connector by a relative movement in a first direction along a first axis, the counterpart connector including a counterpart terminal and a counterpart housing, the connector including: a terminal connectable to the counterpart terminal; a connector housing that accommodates the terminal and is allowed to be fit onto the counterpart housing; a lever that is mounted on the connector housing and is movable relative to the connector housing along the first axis in a range from a first position to a second position ahead of the first position in the first direction; and a lock member that is mounted on the connector housing and is movable relative to the connector housing in a range from a third position to a fourth position, wherein the connector housing is configured to approach a state of fit to the counterpart housing as the lever moves from the first position to the second position, the lock member regulates a movement of the lever by making contact with the lever located at the second position in a state in which the lock member is located at the fourth position, and the lock member is covered with the lever in a state in which the lever is located at the first position or is exposed from the lever in a state in which the lever is located at the second position.

With this configuration, when the lever is moved from the first position to the second position along the first axis, the connector housing is fit into the counterpart housing. Thereafter, when the lock member is located at the fourth position, the lock member regulates the movement of the lever located at the second position, thereby keeping the fit state. The lock member is covered with the lever in a state in which the lever is located at the first position, that is, a state in which the connector housing is not fit onto the counterpart housing, so that the lock member is inoperable. Thus, a wrong operation of the lock member is suppressed. This can avoid problems, for example, interference with a fit of the connector housing onto the counterpart housing because of a wrong operation of the lock member. The lock member is exposed from the lever in a state in which the lever is located at the second position, that is, a state in which the connector housing is fit onto the counterpart housing, so that the lock member is normally operable at the fourth position.

[2] It is preferable that the connector includes an arm that is drivingly coupled to the lever and moves in a direction different from the moving direction of the lever according to a relative movement of the lever, wherein the arm has an engaging portion that is allowed to be engaged with an engaged portion of the counterpart housing, and the connector housing is configured to move relative to the counterpart housing and approach a state of fit to the counterpart housing as the engaging portion in engagement with the engaged portion moves according to a movement of the lever from the first position to the second position.

With this configuration, the arm moves as the lever moves from the first position to the second position, and the engaging portion in engagement with the engaged portion of the counterpart housing also moves, so that the connector housing can be brought close to a state of fit to the counterpart housing.

[3] The lock member is preferably movable in the range from the third position to the fourth position along a second axis crossing the first axis.

With this configuration, the lock member is movable in the range from the third position to the fourth position along the second axis crossing the first axis, thereby firmly keeping a fit state. For example, as compared with a conventional configuration that keeps a state of fit to a small protrusion of a counterpart housing, the protrusion extending in a direction crossing the first axis, a fit state can be more firmly kept. In other words, as compared with a conventional configuration that keeps a state of fit to a small protrusion, the lock member can receive a larger force over a wider range, thereby firmly keeping a fit state. Moreover, the lock member moves along the second axis as a different axis from the first axis along which the lever moves, and comes into contact with the lever. This eliminates the need for, for example, sliding over the protrusion with deformation unlike in the conventional art. Thus, the lock member does not need to have flexibility and can be configured with resistance to breaking, so that a fit state can be firmly kept.

[4] It is preferable that in a state in which the lever is located at the first position, a movement of the lock member from the third position to the fourth position is regulated by bringing the lock member into contact with the lever.

With this configuration, a wrong operation, for example, moving the lock member from the third position to the fourth position with the lever located at the first position can be more prevented.

[5] It is preferable that the lever has a contact portion at the end of the lever on the side of a first opposite direction that is opposite to the first direction, and the lock member regulates a movement of the lever by making contact with the contact portion of the lever located at the second position in a state in which the lock member is located at the fourth position.

With this configuration, the lock member regulates a movement of the lever by making contact with the contact portion at the end of the lever on the side of the first opposite direction, thereby firmly regulating a movement of the lever to the first position with a simple configuration. For example, in a configuration where a contact portion is provided at a portion other than the end of the lever on the side of the first opposite direction, a configuration that protrudes the contact portion in a direction crossing the first axis is necessary, which may lead to a complicated configuration and difficulty in improving rigidity. This problem can be avoided by the foregoing configuration. Thus, a movement of the lever to the first position can be firmly regulated with a simple configuration.

[6] The connector housing preferably includes a support portion capable of holding the lock member with the lever along the first axis in a state in which the lever is located at the second position and the lock member is located at the fourth position.

With this configuration, the lock member that regulates a movement of the lever to the first position is supported by the support portion against a force received from the lever. Thus, a movement of the lever to the first position can be more firmly regulated.

[7] It is preferable that the connector housing includes a mounting portion capable of mounting the lock member, the mounting portion includes a pair of rail grooves extending along the second axis, and the lock member includes a pair of sliding portions that are fit into the rail grooves and are slidable along the rail grooves and a coupling portion that couples the pair of sliding portions.

With this configuration, the lock member is configured such that the pair of sliding portions coupled by the coupling portion are fit into the respective rail grooves of the mounting portion and are guided therein, so that the lock member hardly rattles and can stably move with respect to the connector housing.

[8] It is preferable that the rail groove has a horizontal groove that is recessed in a direction crossing the recessing direction of the rail groove and the sliding portion has a convex portion to be fit into the horizontal groove.

With this configuration, the convex portions fit into the horizontal grooves suppress derailment of the sliding portions in a direction opposite to the recessing direction of the rail grooves, so that the lock member is held by the mounting portion.

[9] It is preferable that the lock member is mounted by a movement relative to the mounting portion in a second direction along the second axis, the mounting portion has a retaining convex portion between the pair of rail grooves, the coupling portion has a retaining portion that suppresses the removal of the lock member from the mounting portion by engagement of the retaining portion with the retaining convex portion in a second opposite direction opposite to the second direction, and the retaining portion is allowed to slide over the retaining convex portion as the coupling portion is deformed by a movement of the lock member relative to the mounting portion in the second direction.

With this configuration, the lock member is mounted by a movement relative to the mounting portion in the second direction along the second axis. The retaining portion of the coupling portion is engaged with the retaining convex portion of the mounting portion in the second opposite direction opposite to the second direction, so that the removal of the lock member from the mounting portion is suppressed. Moreover, the retaining portion is allowed to slide over the retaining convex portion as the coupling portion is deformed by a movement of the lock member relative to the mounting portion in the second direction. Thus, only by moving the lock member relative to the mounting portion in the second direction with a force capable of deforming the coupling portion, the lock member can be mounted without being removed from the mounting portion in the second opposite direction.

[10] It is preferable that the mounting portion has a position-keeping convex portion between the pair of rail grooves, the coupling portion has a position-keeping portion that suppresses a movement of the lock member from the third position to the fourth position and a movement of the lock member from the fourth position to the third position by engagement of the position-keeping portion with the position-keeping convex portion and holds the lock member at the third position or the fourth position, and the position-keeping portion is allowed to slide over the position-keeping convex portion as the coupling portion is deformed by a movement of the lock member relative to the mounting portion along the second axis.

With this configuration, the position-keeping portion of the coupling portion is engaged with the position-keeping convex portion of the mounting portion, so that the lock member is held at the third position or the fourth position. The position-keeping portion is allowed to slide over the position-keeping convex portion as the coupling portion is deformed by a movement of the lock member relative to the mounting portion along the second axis. Thus, the lock member is moved along the second axis with a force capable of deforming the coupling portion, so that the position of the lock member can be switched between the third position and the fourth position.

[11] It is preferable that the coupling portion having the retaining portion and the coupling portion having the position-keeping portion are the same.

With this configuration, for example, as compared with a configuration where a coupling portion having a retaining portion and a coupling portion having a position-keeping portion are separate coupling portions, the lock member has a simpler configuration.

[12] A connector assembly according to the present disclosure includes the connector and the counterpart connector.

With this configuration, a wrong operation of the lock member can be suppressed in the connector assembly.

### Detailed Description of Embodiment of Present Disclosure

A specific example of a connector assembly according to the present disclosure will be described below with reference to the accompanying drawings. In the drawings, some configurations may be exaggerated or simplified for convenience of explanation. Moreover, the scale ratios of parts may vary among the drawings. “Parallel,” “orthogonal,” and “perfect circle” in the present specification mean nearly parallel, nearly orthogonal, and a nearly perfect circle within the scope of the working-effect of the present embodiment as well as strictly parallel, strictly orthogonal, and a strictly perfect circle. The present invention is not limited to these illustrations and is intended to include meanings equivalent to the claims and all changes in the scope.

### [Configuration of Connector Assembly 11]

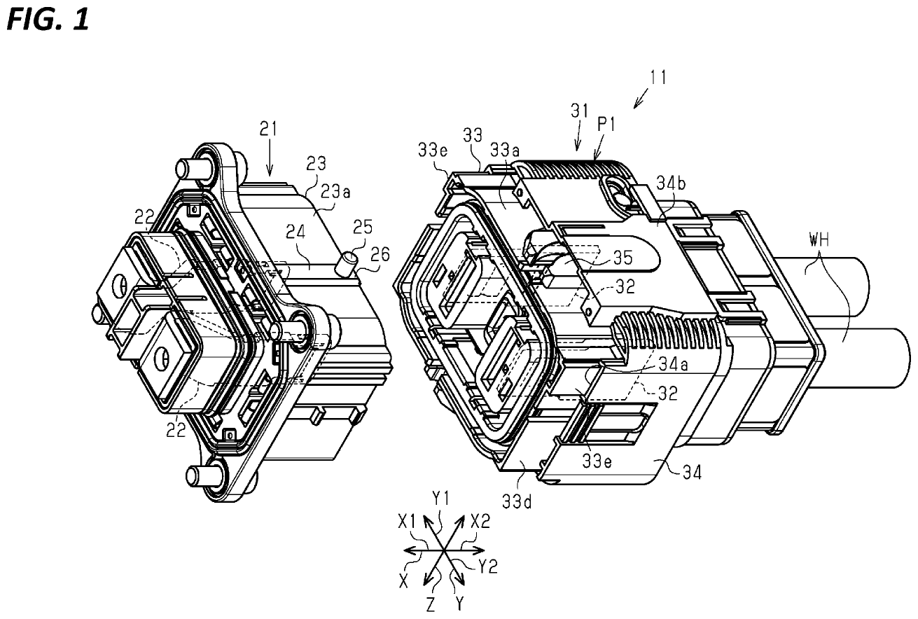

As illustrated in FIG. 1, a connector assembly 11 includes a counterpart connector 21 and a connector 31 that can be connected to the counterpart connector 21 by a relative movement in a first direction X1 along a first axis X. The connector assembly 11 is provided in a vehicle. For example, a vehicle includes onboard equipment including a high pressure battery and an inverter, which are connected to each other via wire harnesses WH. The connector assembly 11 is provided as, for example, a component for connecting the onboard equipment and the wire harnesses WH. FIG. 1 illustrates the first axis X, a second axis Y orthogonal to the first axis X, and a third axis Z orthogonal to the first axis X and the second axis Y. Moreover, FIG. 1 illustrates the first direction X1 that is one direction along the first axis X and a first opposite direction X2 that is the other direction along the first axis X and opposite to the first direction X1. FIG. 1 also illustrates a second direction Y1 that is one direction along the second axis Y and a second opposite direction Y2 that is the other direction along the second axis Y and opposite to the second direction Y1.

### [Configuration of Counterpart Connector 21]

The counterpart connector 21 includes counterpart terminals 22 and a counterpart housing 23 that accommodates the counterpart terminals 22. The counterpart terminals 22 extend along the first axis X. The two counterpart terminals 22 are provided in parallel along the second axis Y. The counterpart terminal 22 has one end connected to, for example, the connecting terminal of onboard equipment in the first direction X1. The counterpart housing 23 is configured with an insulating resin material. The counterpart housing 23 is shaped like a square pillar opened in the first opposite direction X2 opposite to the first direction X1. A wall portion 23a extending along the second axis Y on the counterpart housing 23 has a protruding extension 24 that protrudes outward along the third axis Z and extends along the first axis X. Furthermore, an engaged portion 25 protruding along the third axis Z is provided on the side of the first opposite direction X2 of the protruding extension 24. The engaged portion 25 is shaped like a circular cylinder. Moreover, a portion ahead of the engaged portion 25 in the first opposite direction X2 on the protruding extension 24 constitutes an extruding portion 26. On the counterpart housing 23, one end on the side of the first direction X1 is fixed to, for example, the housing of onboard equipment.

### [Configuration of Connector 31]

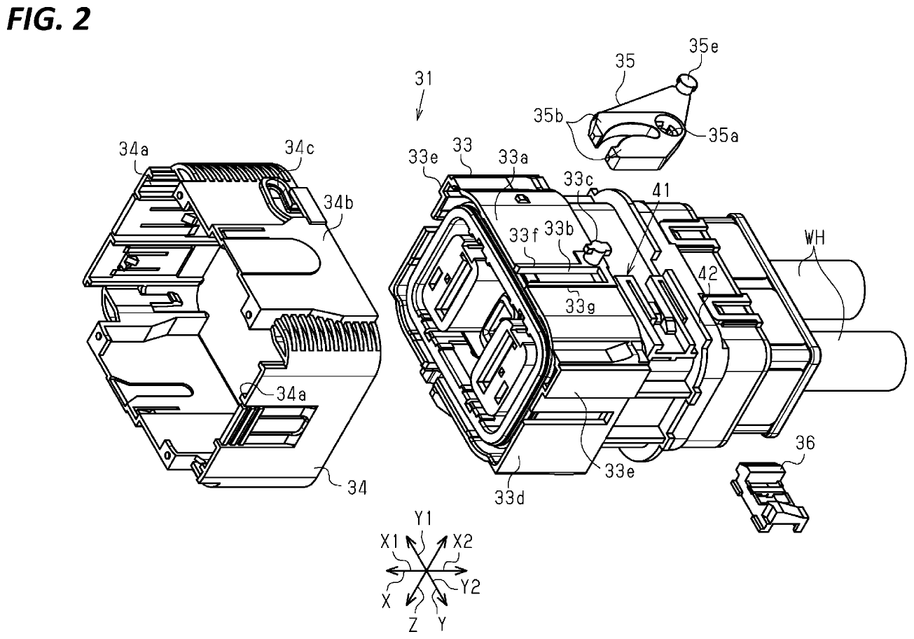

As illustrated in FIGS. 1 and 2, the connector 31 includes terminals 32, a connector housing 33 accommodating the terminals 32, and a lever 34, an arm 35, and a lock member 36 that are attached to the connector housing 33.

### [Configuration of Terminal 32]

As illustrated in FIG. 1, the terminals 32 extend along the first axis X. The two terminals 32 are provided in parallel along the second axis Y and are disposed to be electrically connectable to the respective counterpart terminals 22. On the terminal 32, one end on the side of the first opposite direction X2 is connected to the core wire of the wire harness WH.

### [Configuration of Connector Housing 33]

The connector housing 33 is configured with an insulating resin material.

As illustrated in FIGS. 1 and 2, the connector housing 33 is shaped like a square pillar opened in the first direction X1. The connector housing 33 is configured to be fit onto the counterpart housing 23. Specifically, the connector housing 33 can be fit onto the counterpart housing 23 by moving the connector 31 in the first direction X1 relative to the counterpart connector 21. As illustrated in FIG. 2, on the connector housing 33, a wall portion 33a extending along the second axis Y has a slit 33b that penetrates along the third axis Z and extends along the first axis X. The slit 33b extends in the first opposite direction X2 from one end of the connector housing 33 on the side of the first direction X1. The slit 33b is formed so as to introduce the protruding extension 24 including the extruding portion 26 of the counterpart housing 23. Moreover, the slit 33b allows the engaged portion 25 to move along the first axis X while protruding out of the connector housing 33. The wall portion 33a also has a rotating shaft 33c that projects outward along the third axis Z. The rotating shaft 33c is provided at the center of the connector housing 33 in the width direction along the second axis Y. Moreover, a wall portion 33d extending along the third axis Z on the connector housing 33 has a rail portion 33e that protrudes outward along the second axis Y and extends along the first axis X. As illustrated in FIG. 2, a thick portion 33f having a larger thickness than other portions is formed around the slit 33b on the wall portion 33a. Thus, the wall portion 33a has a step 33g on the edge of the thick portion 33f.

The wall portion 33a also have a mounting portion 41 where the lock member 36 can be mounted. The mounting portion 41 allows the lock member 36 to be mounted by a relative movement to the mounting portion 41 in the second direction Y1 along the second axis Y. The mounting portion 41 is provided ahead of the slit 33b and the rotating shaft 33c in the first opposite direction X2 on the wall portion 33a. Moreover, the mounting portion 41 is provided ahead of the slit 33b and the rotating shaft 33c in the second opposite direction Y2, which is opposite to the second direction Y1, on the wall portion 33a.

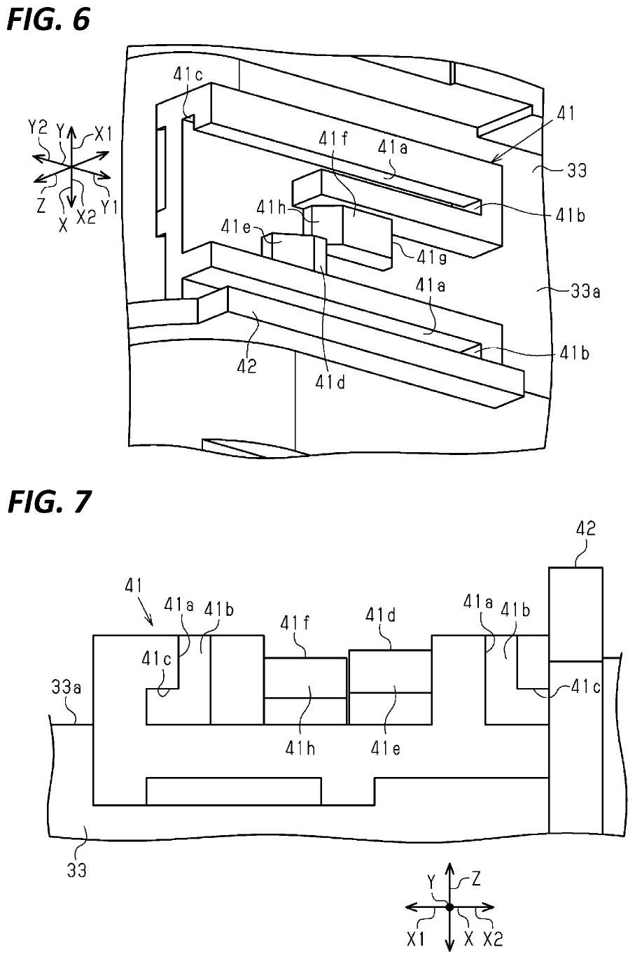

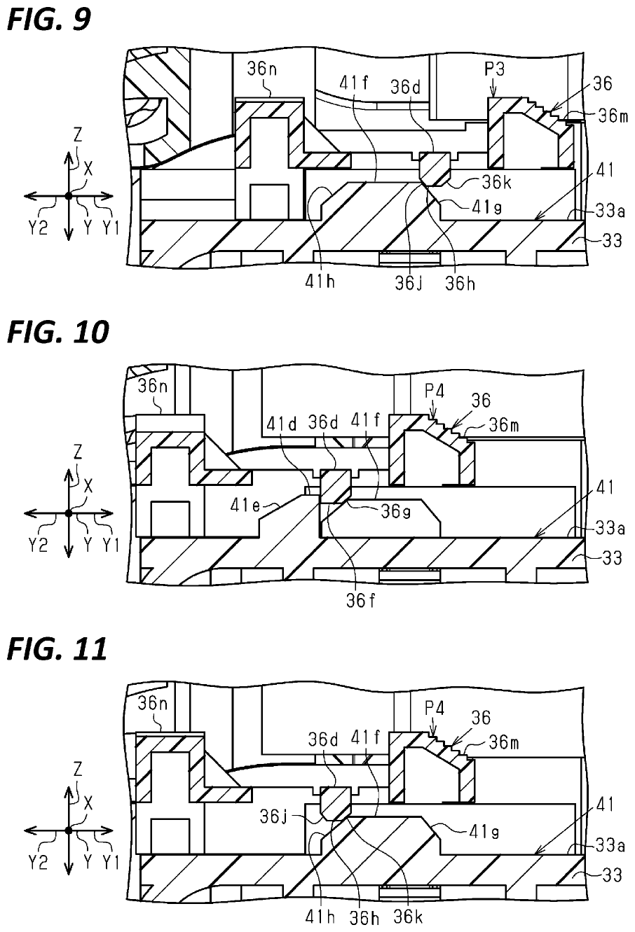

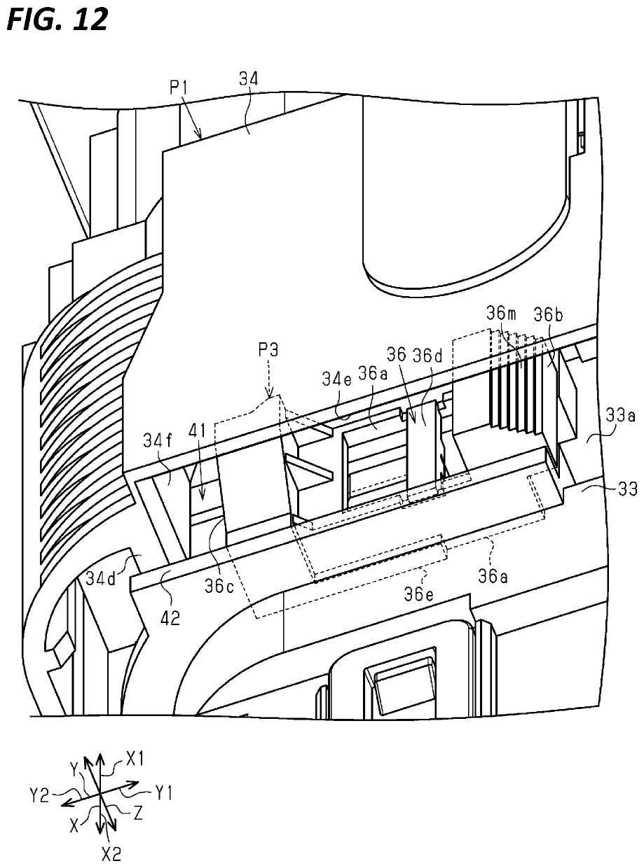

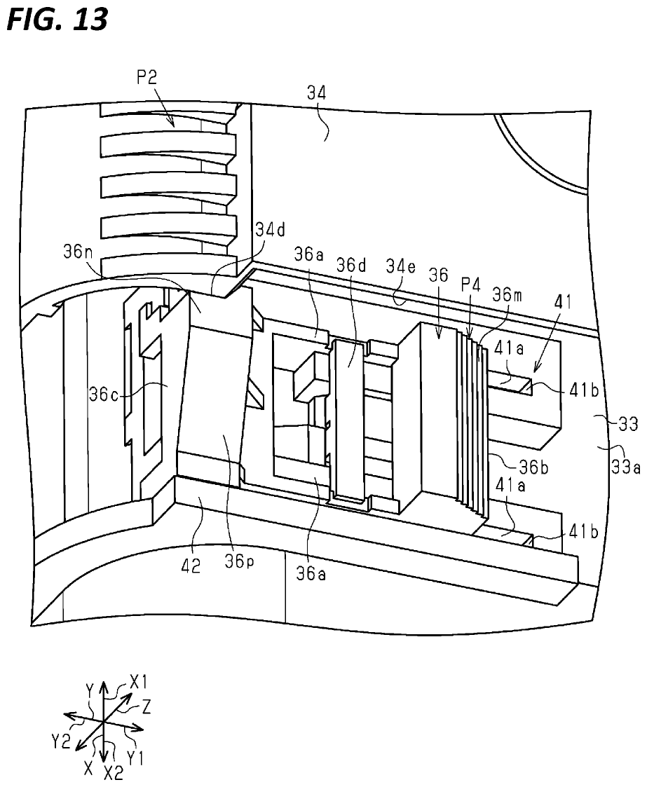

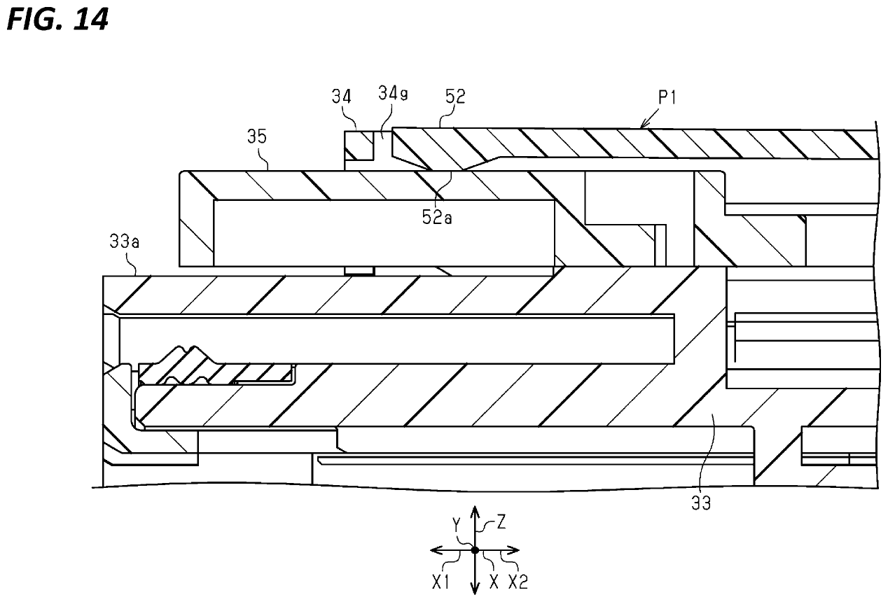

As illustrated in FIGS. 6 and 7, the mounting portion 41 has a pair of rail grooves 41a that are recessed along the third axis Z and extend along the second axis Y. The rail grooves 41a are opened in the second opposite direction Y2. The mounting portion 41 also has terminal end portions 41b that close the rail grooves 41a in the second direction Y1 at the ends of the rail grooves 41a on the side of the second direction Y1. The rail groove 41a has a horizontal groove 41c that is recessed in a direction crossing the recessing direction of the rail groove 41a. The mounting portion 41 also has a retaining convex portion 41d between the pair of rail grooves 41a. As illustrated in FIG. 10, the retaining convex portion 41d has an inclined face 41e at the corner on the side of the second opposite direction Y2. The mounting portion 41 also has a position-keeping convex portion 41f between the pair of rail grooves 41a. As illustrated in FIG. 6, the position-keeping convex portion 41f is shifted in the first direction X1 relative to the retaining convex portion 41d. The position-keeping convex portion 41f is shifted in the second direction Y1 relative to the retaining convex portion 41d. As illustrated in FIGS. 9 and 11, the position-keeping convex portion 41f has an inclined face 41g at a corner on the side of the second direction Y1. The position-keeping convex portion 41f has an inclined face 41h at a corner on the side of the second opposite direction Y2. As illustrated in FIGS. 6 and 7, the wall portion 33a of the connector housing 33 has a support portion 42. The support portion 42 is provided on the side of the first opposite direction X2 on the mounting portion 41. The support portion 42 is erected along the third axis Z and extends along the second axis Y. As illustrated in FIGS. 12 and 13, the support portion 42 is provided to be contactable with an end face of the lock member 36, which is mounted on the mounting portion 41, on the side of the first opposite direction X2.

### [Configuration of Lever 34]

The lever 34 is configured with a resin material.

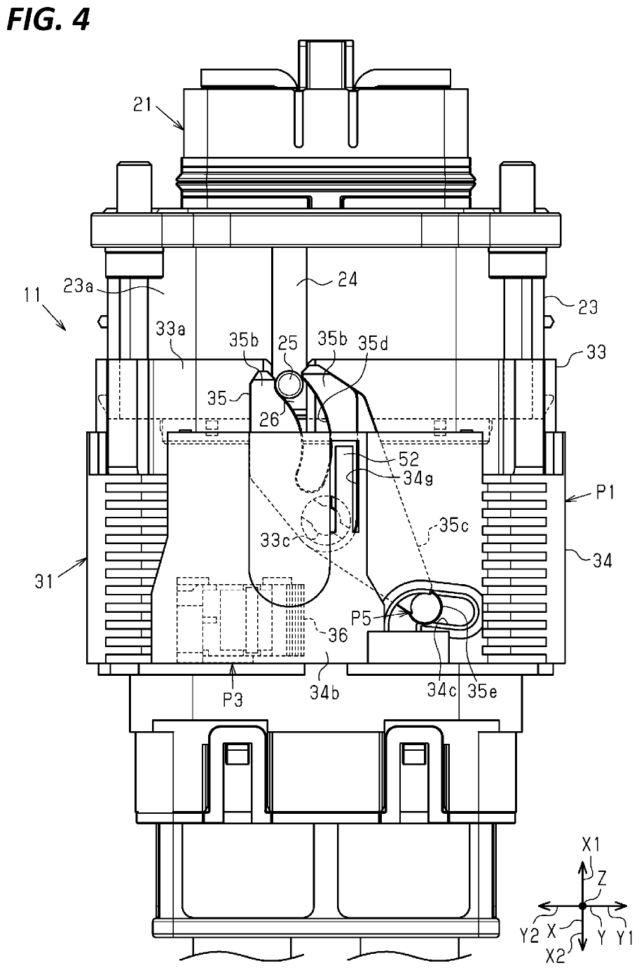

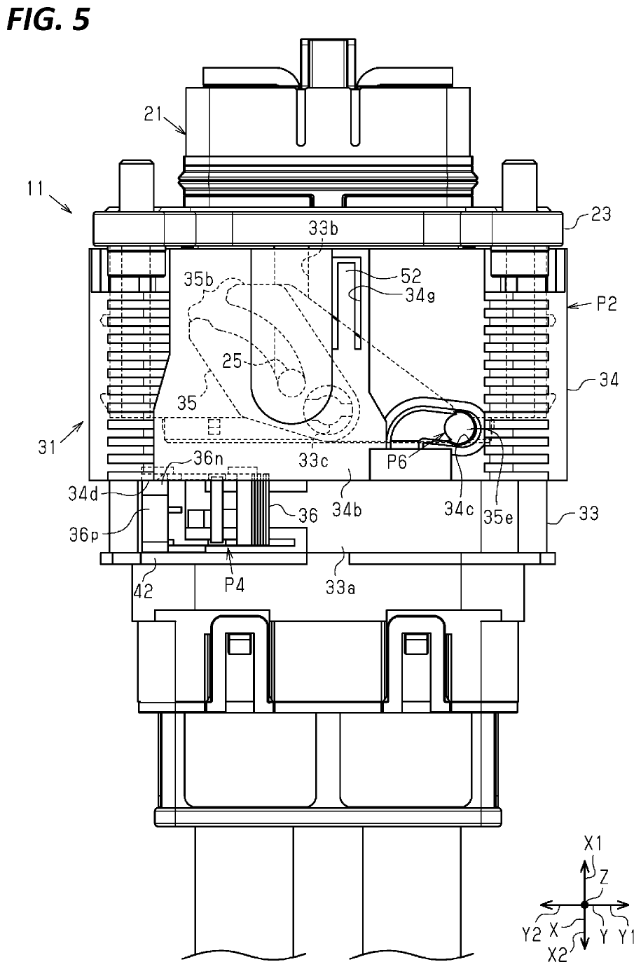

As illustrated in FIGS. 1 and 2, the lever 34 is shaped like a square pillar. The inner surface of the lever 34 has a concave portion 34a that extends along the first axis X and can be fit onto the rail portion 33e of the connector housing 33. The lever 34 is fit onto the connector housing 33. The lever 34 can be moved relative to the connector housing 33 along the first axis X by guiding the concave portion 34a to the rail portion 33e. The lever 34 can be moved relative to the connector housing 33 in the range from a first position P1 (see FIGS. 1 and 4) on the side of the first opposite direction X2 to a second position P2 (see FIG. 5) located ahead of the first position P1 in the first direction X1.

As illustrated in FIGS. 4 and 5, on the lever 34, a wall portion 34b extending along the second axis Y has a coupled portion 34c penetrating along the third axis Z. The coupled portion 34c is provided near one end on the lever 34 in the second direction Y1 along the second direction Y1. The coupled portion 34c extends along the second axis Y and slightly tilts toward the first opposite direction X2 as extending along the second direction Y1.

As illustrated in FIG. 5, the lever 34 has a contact portion 34d. The contact portion 34d is provided on one end of the lever 34 on the side of the first opposite direction X2. In other words, a part of one end face of the lever 34 on the side of the first opposite direction X2 serves as the contact portion 34d.

### [Configuration of Arm 35]

The arm 35 is configured with a resin material.

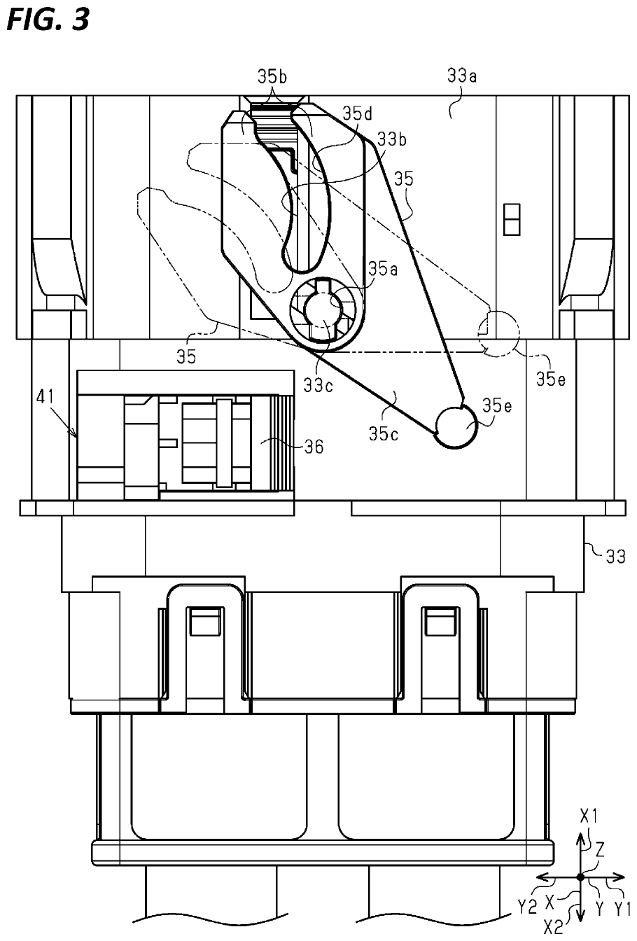

As illustrated in FIG. 3, the arm 35 has a central hole 35a, a pair of engaging portions 35b extending in one direction with respect to the central hole 35a, and an extended portion 35c that extends to the other direction opposite from the engaging portions 35b with respect to the central hole 35a. The arm 35 is attached to the connector housing 33 such that the rotating shaft 33c passes through the central hole 35a. In other words, the arm 35 is supported so as to pivot about the rotating shaft 33c. The arm 35 is provided such that the pair of engaging portions 35b pivots about the central hole 35a on the side of the second opposite direction Y2 that is opposite to the second direction Y1 and the extended portion 35c pivots about the central hole 35a on the side of the second direction Y1.

The pair of engaging portions 35b has opposing surfaces constituting a slit 35d. As illustrated in FIG. 4, the clearance of the slit 35d is set such that the engaged portion 25 of the counterpart housing 23 can be inserted into the slit 35d. Thus, the pair of engaging portions 35b can be engaged with the engaged portion 25. The slit 35d is curved in a direction that can draw the engaged portion 25 to the proximal side of the engaging portions 35b, that is, the side of the first opposite direction X2 by pivoting the arm 35 to move the distal-end side of the pair of engaging portions 35b in the first opposite direction X2.

The distal-end portion of the extended portion 35c has a coupling shaft 35e that projects along the third axis Z. As illustrated in FIGS. 4 and 5, the coupling shaft 35e is provided to penetrate the coupled portion 34c of the lever 34. The coupling shaft 35e is drivingly coupled to the lever 34 so as to move the arm 35 in a direction different from the moving direction of the lever 34 according to a relative movement of the lever 34 along the first axis X. In other words, the coupling shaft 35e is drivingly coupled to the lever 34 so as to pivot the arm 35 while moving in the coupled portion 34c according to a relative movement of the lever 34 along the first axis X. Thus, the arm 35 is drivingly coupled to the lever 34.

With this configuration, the connector housing 33 is configured to approach a state of fit to the counterpart housing 23 as the lever 34 moves from the first position P1 (see FIG. 4) to the second position P2 (see FIG. 5). Specifically, the connector housing 33 is configured to move relative to the counterpart housing 23 and approach a state of fit to the counterpart housing 23 as the engaging portions 35b in engagement with the engaged portion 25 of the counterpart housing 23 move according to a movement of the lever 34 from the first position P1 to the second position P2. In other words, as the lever 34 moves from the first position P1 to the second position P2, the coupling shaft 35e penetrating the coupled portion 34c of the lever 34 moves from a fifth position P5 (see FIG. 4) to a sixth position P6 (see FIG. 5) and pivots the arm 35. Thus, the engaging portions 35b moving with the arm 35 operate to draw the engaged portion 25, so that the connector housing 33 moves relative to the counterpart housing 23 and approaches a state of fit to the counterpart housing 23.

### [Configuration of Lock Member 36]

The lock member 36 is configured with a resin material.

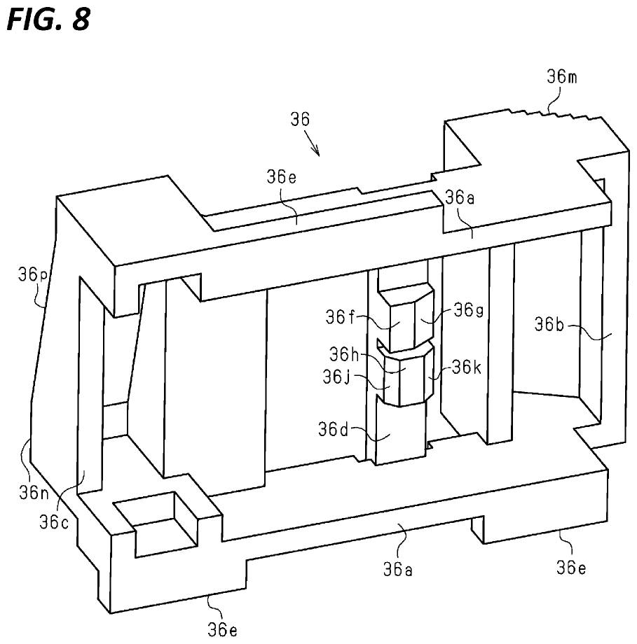

As illustrated in FIGS. 8, 12, and 13, the lock member 36 includes a pair of sliding portions 36a, a first coupling portion 36b that couples the pair of sliding portions 36a, a second coupling portion 36c, and a third coupling portion 36d. The sliding portions 36a are fit into the rail grooves 41a of the mounting portion 41 and are slidable along the rail grooves 41a. The sliding portion 36a has a convex portion 36e to be fit into the horizontal groove 41c of the rail groove 41a. The sliding portions 36a are fit into the rail grooves 41a and the convex portions 36e are fit into the horizontal grooves 41c by moving the lock member 36 relative to the mounting portion 41 in the second direction Y1, so that the lock member 36 is mounted on the mounting portion 41. The lock member 36 can be moved relative to the connector housing 33 in the range from a third position P3 (see FIGS. 4, 9, and 12) to a fourth position P4 (see FIGS. 5, 10, 11 and 13) along the second axis Y by sliding the sliding portions 36a along the rail grooves 41a.

In a state in which the lock member 36 is mounted on the mounting portion 41, the first coupling portion 36b couples the ends of the pair of sliding portions 36a on the side of the second direction Y1. The second coupling portion 36c couples the ends of the pair of sliding portions 36a on the side of the second opposite direction Y2. The third coupling portion 36d couples the intermediate portions of the sliding portions 36a.

As illustrated in FIGS. 8 and 10, the third coupling portion 36d has a retaining portion 36f. The retaining portion 36f protrudes from the third coupling portion 36d toward the wall portion 33a of the connector housing 33. As illustrated in FIG. 10, in a state in which the lock member 36 is located at the fourth position P4, the retaining portion 36f suppresses the removal of the lock member 36 from the mounting portion 41 by engagement of the retaining portion 36f with the retaining convex portion 41d in the second opposite direction Y2.

The retaining portion 36f has an inclined face 36g at a corner on the side of the second direction Y1. The inclined face 36g of the retaining portion 36f and the inclined face 41e of the retaining convex portion 41d generate component forces that deform the third coupling portion 36d in a direction separating from the wall portion 33a of the connector housing 33 when the lock member 36 is assembled onto the mounting portion 41. With this configuration, the retaining portion 36f is allowed to slide over the retaining convex portion 41d as the third coupling portion 36d is deformed by a movement of the lock member 36 relative to the mounting portion 41 in the second direction Y1. Thus, the lock member 36 is moved relative to the mounting portion 41 in the second direction Y1, so that the lock member 36 can be smoothly mounted on the mounting portion 41.

As illustrated in FIGS. 8, 9, and 11, the third coupling portion 36d has a position-keeping portion 36h. The position-keeping portion 36h protrudes from the third coupling portion 36d toward the wall portion 33a of the connector housing 33. As illustrated in FIG. 9, in a state in which the lock member 36 is located at the third position P3, the position-keeping portion 36h is engaged with the position-keeping convex portion 41f in the second opposite direction Y2, so that a movement of the lock member 36 from the third position P3 to the fourth position P4 is suppressed to hold the lock member 36 at the third position P3. A movement of the lock member 36 at the third position P3 in the second direction Y1 is suppressed by the terminal end portions 41b (see FIG. 6). As illustrated in FIG. 11, in a state in which the lock member 36 is located at the fourth position P4, the position-keeping portion 36h is engaged with the position-keeping convex portion 41f in the second direction Y1, so that a movement of the lock member 36 from the fourth position P4 to the third position P3 is suppressed to hold the lock member 36 at the fourth position P4. A movement of the lock member 36 at the fourth position P4 in the second opposite direction Y2 is suppressed by the retaining convex portion 41d (see FIG. 10).

The position-keeping portion 36h has an inclined face 36j at a corner on the side of the second opposite direction Y2. The inclined face 36j of the position-keeping portion 36h and the inclined face 41g of the position-keeping convex portion 41f generate component forces that deform the third coupling portion 36d in a direction separating from the wall portion 33a of the connector housing 33 when the lock member 36 is moved from the third position P3 to the fourth position P4. The position-keeping portion 36h has an inclined face 36k at a corner on the side of the second direction Y1. The inclined face 36k of the position-keeping portion 36h and the inclined face 41h of the position-keeping convex portion 41f generate component forces that deform the third coupling portion 36d in a direction separating from the wall portion 33a of the connector housing 33 when the lock member 36 is moved from the fourth position P4 to the third position P3. With this configuration, the position-keeping portion 36h is allowed to slide over the position-keeping convex portion 41f as the third coupling portion 36d is deformed by a movement of the lock member 36 relative to the mounting portion 41 along the second axis Y. Thus, the lock member 36 is moved along the second axis Y with a force capable of deforming the third coupling portion 36d, so that the position of the lock member 36 can be switched between the third position P3 and the fourth position P4.

The first coupling portion 36b has an operation portion 36m. The operation portion 36m is shaped like, for example, steps that allow an operator to easily operate the lock member 36 with the fingers.

The second coupling portion 36c has a lock portion 36n. As illustrated in FIGS. 5 and 13, the lock portion 36n regulates a movement of the lever 34 to the first position P1 by making contact with the contact portion 34d of the lever 34 at the second position P2 in a state in which the lock member 36 is located at the fourth position P4. Furthermore, in a state in which the lock member 36 is located at the fourth position P4, the lock portion 36n is held by the contact portion 34d of the lever 34 located at the second position P2 and the support portion 42 of the connector housing 33 along the first axis X. The lock portion 36n of the present embodiment has an inclined portion 36p that gradually decreases in height toward the support portion 42, that is, toward the first opposite direction X2 according to a height of the support portion 42 from the wall portion 33a.

As illustrated in FIGS. 4 and 12, in a state in which the lock member 36 is located at the third position P3 and the lever 34 is located at the first position P1, the lock member 36 is covered with the lever 34. Specifically, as illustrated in FIG. 12, the lever 34 has a storage portion 34e that accommodates the lock member 36 between the wall portion 33a and the storage portion 34e in a state in which the lock member 36 is located at the third position P3 and the lever 34 is located at the first position P1.

In a state in which the lever 34 is located at the first position P1, the lock member 36 is brought into contact with the lever 34, so that a movement of the lock member 36 from the third position P3 to the fourth position P4 is regulated. Specifically, as illustrated in FIG. 12, the lever 34 has a regulating surface 34f that regulates a movement of the lock member 36 to the fourth position P4 in a state in which the lock member 36 is located at the third position P3 and the lever 34 is located at the first position P1. The regulating surface 34f is configured with the inner wall surface of the storage portion 34e.

As illustrated in FIGS. 5 and 13, the lock member 36 is exposed from the lever 34 in a state in which the lever 34 is located at the second position P2. Specifically, in a state in which the lever 34 is located at the second position P2, the lock member 36 is exposed from the lever 34 to allow an operator to operate the lock member 36 with the fingers and cannot come into contact with the regulating surface 34f, so that the lock member 36 can be moved from the third position P3 to the fourth position P4.

### [Configuration for Keeping Initial Position of Arm 35]

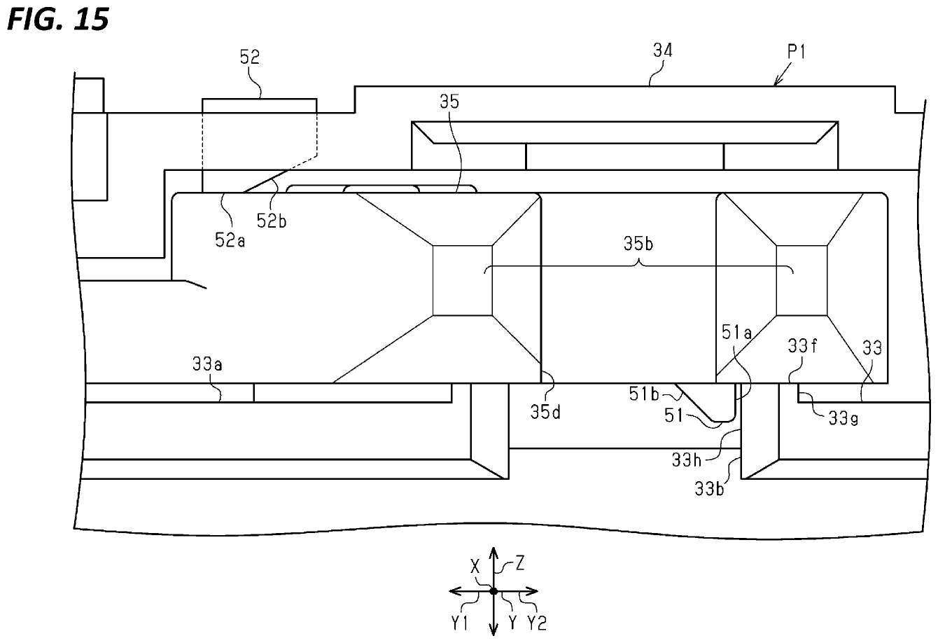

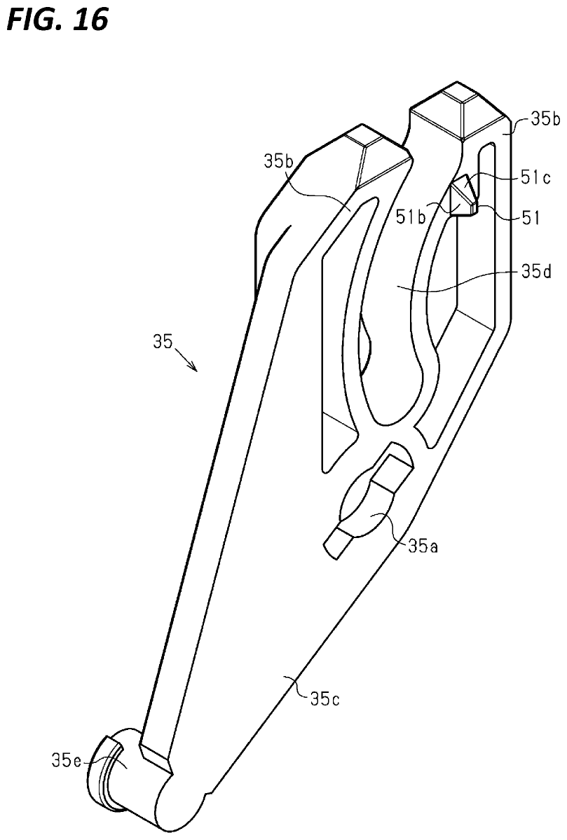

As illustrated in FIGS. 15 and 16, the arm 35 has a locking protrusion 51. As illustrated in FIG. 15, in a state in which the lever 34 is located at the first position P1, the locking protrusion 51 is fit into the slit 33b, so that a movement of the arm 35 can be regulated at the initial position.

As illustrated in FIGS. 4, 14, and 15, the lever 34 has an elastic piece 52. As illustrated in FIG. 15, the elastic piece 52 presses the arm 35 in a direction that fits the locking protrusion 51 into the slit 33b.

Thereafter, the locking protrusion 51 is pressed out of the slit 33b by the extruding portion 26 of the counterpart housing 23 in an initial state of fit into the connector housing 33. As illustrated in FIG. 4, the initial fit state is a state in which the connector housing 33 and the counterpart housing 23 are slightly fit to each other, that is, a state in which the engaged portion 25 is placed between the distal-end portions of the pair of engaging portions 35b into engagement with the engaging portions 35b.

Specifically, as illustrated in FIG. 15, the locking protrusion 51 has a locking face 51a that can come into contact with an inner wall surface 33h of the slit 33b. When the lever 34 starts moving from the first position P1 to the second position P2 with the locking protrusion 51 fit into the slit 33b, the locking face 51a comes into contact with the inner wall surface 33h of the slit 33b to prevent component forces from being generated in a direction against the pressing force of the elastic piece 52. In other words, the inner wall surface 33h and the locking face 51a are parallel flat surfaces along the third axis Z. When the lever 34 starts moving from the first position P1 to the second position P2 to pivot the arm 35 with the locking protrusion 51 fit into the slit 33b, the locking face 51a comes into surface contact with the inner wall surface 33h in a direction orthogonal to the third axis Z to regulate the movement of the arm 35.

The locking protrusion 51 has a first inclined face 51b. The first inclined face 51b is inclined with respect to a plane along the third axis Z. The first inclined face 51b generates component forces that allow the lever 34 to slide over the step 33g on a surface facing the arm 35 on the connector housing 33 when the lever 34 moves from the second position P2 side to the first position P1 side.

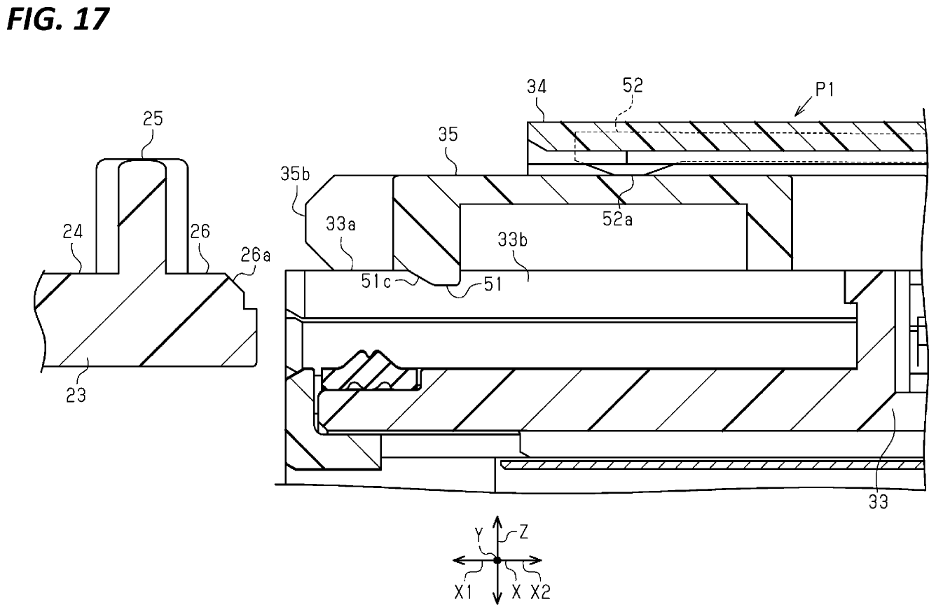

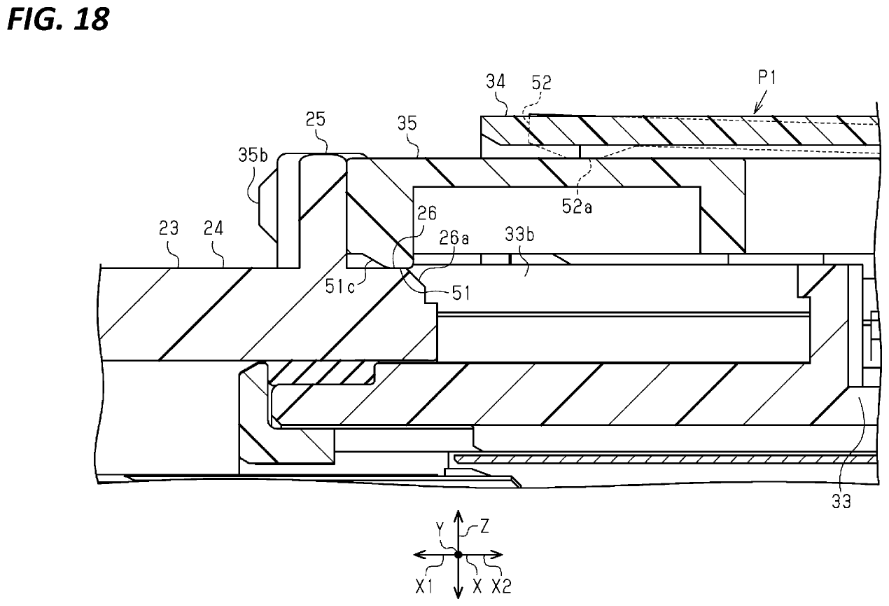

As illustrated in FIGS. 16 to 18, the locking protrusion 51 has a second inclined face 51c. The second inclined face 51c is inclined with respect to a plane along the third axis Z. The second inclined face 51c comes into contact with the extruding portion 26 so as to generate component forces in the direction of extrusion from the slit 33b when the connector housing 33 and the counterpart housing 23 approach the initial fit state. FIG. 17 illustrates a state in which the connector housing 33 and the counterpart housing 23 are not fit to each other. FIG. 18 illustrates an initial state of fit between the connector housing 33 and the counterpart housing 23. The extruding portion 26 of the present embodiment has an inclined face 26a that comes into contact with the locking protrusion 51 so as to generate component forces in a direction that presses the locking protrusion 51 out of the slit 33b when approaching the initial fit state.

As illustrated in FIGS. 4 and 5, the elastic piece 52 is provided on a part of the wall portion 34b of the lever 34. The wall portion 34b has a U-shaped slit 34g, and a portion determined by the slit 34g constitutes the elastic piece 52.

As illustrated in FIG. 14, the elastic piece 52 has a pressing portion 52a at the distal-end portion. The pressing portion 52a protrudes to the arm 35. The elastic piece 52 presses the arm 35 with the pressing portion 52a in a state in which the lever 34 is located at the first position P1. The elastic piece 52 does not press the arm 35 in a state in which the lever 34 is not located at the first position P1. For example, as illustrated in FIG. 5, in a state in which the lever 34 is located at the second position P2, the elastic piece 52 is displaced from the arm 35 and does not press the arm 35.

As illustrated in FIG. 15, the pressing portion 52a has a third inclined face 52b. The third inclined face 52b generates component forces that allow the pressing portion 52a to slide over the arm 35 when the lever 34 moves from the second position P2 side to the first position P1 side.

Operations performed when the connector assembly 11 configured thus is connected will be describe below.

As illustrated in FIG. 1, before the connector 31 is connected to the counterpart connector 21, the lever 34 is located at the first position P1. In a state in which the lever 34 is located at the first position P1, as illustrated in FIG. 15, the arm 35 is pressed in a direction along which the locking protrusion 51 is fit into the slit 33b by the elastic piece 52. The rotation of the arm 35 is suppressed by the locking protrusion 51 fit into the slit 33b, so that the arm 35 is kept at the initial position. Thus, the movement of the lever 34 to the second position P2 is also suppressed while the lever 34 is drivingly coupled to the arm 35. As illustrated in FIGS. 4 and 12, in a state in which the lever 34 is located at the first position P1, the lock member 36 at the third position P3 is covered with the lever 34. In a state in which the lever 34 is located at the first position P1, as illustrated in FIG. 12, a movement of the lock member 36 from the third position P3 to the fourth position P4 is regulated by bringing the lock member 36 into contact with the regulating surface 34f of the lever 34.

Furthermore, when the connector 31 is connected to the counterpart connector 21, an operator moves the connector 31 relative to the counterpart connector 21 in the first direction X1 and places the connector housing 33 into an initial fit state in which the connector housing 33 is slightly fit onto the counterpart housing 23. Thus, as illustrated in FIG. 18, the extruding portion 26 of the counterpart housing 23 is introduced into the slit 33b. Thereafter, the locking protrusion 51 of the arm 35 is pressed out of the slit 33b by the extruding portion 26 against the pressing force of the elastic piece 52. Thus, a movement of the arm 35 from the initial position, that is, a rotation is permitted, and a movement of the lever 34 to the second position P2 is also permitted while the lever 34 is drivingly coupled to the arm 35. The engaged portion 25 of the counterpart housing 23 is inserted into the slit 35d between the pair of engaging portions 35b and is placed in engagement with the engaging portions 35b.

The operator then holds the lever 34 to move the lever 34 in the first direction X1. Thus, the lever 34 moves from the first position P1 to the second position P2. At this point, the arm 35 pivots to move the engaging portions 35b in engagement with the engaged portion 25 as the lever 34 moves. The engaging portions 35b at this point operate to draw the engaged portion 25 inward, allowing the connector housing 33 to move relative to the counterpart housing 23 into a fit state in which the connector housing 33 is completely fit onto the counterpart housing 23. Thus, the terminals 32 are electrically connected to the counterpart terminals 22. In a state in which the lever 34 is located at the second position P2, the lock member 36 is exposed from the lever 34. Specifically, in a state in which the lever 34 is located at the second position P2, the lock member 36 is operably exposed from the lever 34 and cannot come into contact with the regulating surface 34f, so that a movement of the lock member 36 from the third position P3 to the fourth position P4 is permitted.

The operator then operates the operation portion 36m of the lock member 36 to move the lock member 36 from the third position P3 to the fourth position P4. Thus, as illustrated in FIGS. 5 and 13, the lock portion 36n of the lock member 36 can come into contact with the contact portion 34d of the lever 34 located at the second position P2, so that a movement of the lever 34 to the first position P1 is regulated. This suppresses disengagement of the connector housing 33 from the counterpart housing 23, the disengagement being caused by, for example, external forces such as vibrations.

The effects of the embodiment will be described below.

(1) When the lever 34 is moved from the first position P1 to the second position P2 along the first axis X, the connector housing 33 is fit onto the counterpart housing 23. Thereafter, when the lock member 36 is located at the fourth position P4, the lock member 36 regulates the movement of the lever 34 located at the second position P2, thereby keeping the fit state. The lock member 36 is covered with the lever 34 in a state in which the lever 34 is located at the first position P1, that is, a state in which the connector housing 33 is not fit onto the counterpart housing 23, so that the lock member 36 is inoperable. Thus, a wrong operation of the lock member 36 is suppressed. This can avoid interference with a movement of the lever 34 in the event of, for example, a wrong operation of the lock member 36, thereby avoiding problems, for example, interference with a fit of the connector housing 33 onto the counterpart housing 23. The lock member 36 is exposed from the lever 34 in a state in which the lever 34 is located at the second position P2, that is, a state in which the connector housing 33 is fit onto the counterpart housing 23, so that the lock member 36 is normally operable at the fourth position P4.

(2) The arm 35 has the engaging portions 35b that can be engaged with the engaged portion 25 of the counterpart housing 23. The arm 35 then moves as the lever 34 moves from the first position P1 to the second position P2, and the engaging portions 35b in engagement with the engaged portion 25 of the counterpart housing 23 also move, so that the connector housing 33 can be brought close to a state of fit to the counterpart housing 23.

(3) The lock member 36 can move in the range from the third position P3 to the fourth position P4 along the second axis Y crossing the first axis X, thereby firmly keeping a fit state. For example, as compared with a conventional configuration that keeps a state of fit to a small protrusion of a counterpart housing, the protrusion extending in a direction crossing the first axis X, a fit state can be more firmly kept. In other words, as compared with a conventional configuration that keeps a state of fit to a small protrusion, the lock member 36 can receive a larger force over a wider range, thereby firmly keeping a fit state. Moreover, the lock member 36 moves along the second axis Y as a different axis from the first axis X along which the lever 34 moves, and comes into contact with the lever 34. This eliminates the need for, for example, sliding over the protrusion with deformation unlike in the conventional art. Thus, the lock member 36 does not need to have flexibility and can be configured with resistance to breaking, so that a fit state can be firmly kept.

(4) In a state in which the lever 34 is located at the first position P1, a movement of the lock member 36 from the third position P3 to the fourth position P4 is regulated by bringing the lock member 36 into contact with the lever 34. Thus, a wrong operation, for example, moving the lock member 36 from the third position P3 to the fourth position P4 with the lever 34 located at the first position P1 can be prevented.

(5) The lock member 36 regulates a movement of the lever 34 by making contact with the contact portion 34d at the end of the lever 34 on the side of the first opposite direction X2, thereby firmly regulating a movement of the lever 34 to the first position P1 with a simple configuration. For example, in a configuration where a contact portion is provided at a portion other than the end of the lever 34 on the side of the first opposite direction X2, a configuration that protrudes the contact portion in a direction crossing the first axis X is necessary. This may lead to a complicated configuration and difficulty in improving rigidity. This problem can be avoided by the foregoing configuration. Thus, a movement of the lever 34 to the first position P1 can be firmly regulated with a simple configuration.

(6) The connector housing 33 includes the support portion 42 capable of holding the lock member 36 with the lever 34 along the first axis X in a state in which the lever 34 is located at the second position P2 and the lock member 36 is located at the fourth position P4. Thus, the lock member 36 that regulates a movement of the lever 34 to the first position P1 is supported by the support portion 42 against a force received from the lever 34. Thus, a movement of the lever 34 to the first position P1 can be more firmly regulated.

(7) The mounting portion 41 of the connector housing 33 has the pair of rail grooves 41a that extend along the second axis Y. The lock member 36 is configured such that the pair of sliding portions 36a coupled by the first coupling portion 36b, the second coupling portion 36c, and the third coupling portion 36d is fit into the rail grooves 41a and is guided therein. Thus, the lock member 36 hardly rattles and can stably move with respect to the connector housing 33.

(8) The rail groove 41a has the horizontal groove 41c that is recessed in the direction crossing the recessing direction of the rail groove 41a, and the sliding portion 36a has the convex portion 36e to be fit into the horizontal groove 41c. The convex portions 36e fit into the horizontal grooves 41c suppress derailment of the sliding portions 36a in a direction opposite to the recessing direction of the rail grooves 41a, so that the lock member 36 is held by the mounting portion 41.

(9) The lock member 36 is mounted by a movement relative to the mounting portion 41 in the second direction Y1 along the second axis Y. The retaining portion 36f of the third coupling portion 36d is engaged with the retaining convex portion 41d of the mounting portion 41 in the second opposite direction Y2 opposite to the second direction Y1, so that the removal of the lock member 36 from the mounting portion 41 is suppressed. Moreover, the retaining portion 36f is allowed to slide over the retaining convex portion 41d as the third coupling portion 36d is deformed by a movement of the lock member 36 relative to the mounting portion 41 in the second direction Y1. Thus, only by moving the lock member 36 relative to the mounting portion 41 in the second direction Y1 with a force capable of deforming the third coupling portion 36d, the lock member 36 can be mounted without being removed from the mounting portion 41 in the second opposite direction Y2.

(10) The position-keeping portion 36h of the third coupling portion 36d is engaged with the position-keeping convex portion 41f of the mounting portion 41, so that the lock member 36 is held at the third position P3 or the fourth position P4. The position-keeping portion 36h is allowed to slide over the position-keeping convex portion 41f as the third coupling portion 36d is deformed by a movement of the lock member 36 relative to the mounting portion 41 along the second axis Y. Thus, the lock member 36 is moved along the second axis Y with a force capable of deforming the third coupling portion 36d, so that the position of the lock member 36 can be switched between the third position P3 and the fourth position P4.

(11) The retaining portion 36f and the position-keeping portion 36h are provided on the same third coupling portion 36d. Thus, for example, as compared with a configuration where a coupling portion having the retaining portion 36f and a coupling portion having the position-keeping portion are separate coupling portions, the lock member 36 has a simpler configuration.

The present embodiment can be implemented with the modifications below. The present embodiment and the following modification examples can be implemented in combination unless technical contradictions arise.
In the foregoing embodiment, the arm 35 has the engaging portions 35b that can be engaged with the engaged portion 25 of the counterpart housing 23. The configuration is not limited thereto, and the engaging portions 35b may be omitted. In other words, the connector housing 33 may be modified to another configuration if the configuration approaches a state of fit to the counterpart housing 23 as the lever 34 moves from the first position P1 to the second position P2. For example, the arm 35 may be configured to be drivingly coupled to still another member that is engaged with the counterpart housing 23 to operate in the same manner as in the foregoing embodiment.
In the foregoing embodiment, the lock member 36 can move in the range of the third position P3 and the fourth position P4 along the second axis Y crossing the first axis X. The configuration is not limited thereto. For example, the lock member 36 may be configured to move along the first axis X.
In the foregoing embodiment, in a state in which the lever 34 is located at the first position P1, a movement of the lock member 36 from the third position P3 to the fourth position P4 is regulated by bringing the lock member 36 into contact with the lever 34. The configuration is not limited thereto, and the regulation may be omitted.
In the foregoing embodiment, a movement of the lever 34 is regulated by bringing the lock member 36 into contact with the contact portion 34d at the end of the lever 34 on the side of the first opposite direction X2. The configuration is not limited thereto, and the lock member 36 may come into contact with a contact portion provided at another portion of the lever.
In the foregoing embodiment, the connector housing 33 has the support portion 42 capable of holding the lock member 36 with the lever 34 along the first axis X. The configuration is not limited thereto, and the support portion 42 may be omitted. The lock portion 36n of the lock member 36 has the inclined portion 36p that is inclined according to a height of the support portion 42 from the wall portion 33a. The configuration is not limited thereto, and the inclined portion 36p may be omitted.
In the foregoing embodiment, the mounting portion 41 of the connector housing 33 may be modified to another configuration along with the configuration of the lock member 36 if the lock member 36 can be movably held.

For example, the mounting portion 41 may guide the lock member by using another configuration without the pair of rail grooves 41a.

For example, the mounting portion 41 may suppress derailment of the lock member 36 from the rail grooves 41a by using another configuration without the horizontal grooves 41c provided for the rail grooves 41a.

Moreover, for example, the mounting portion 41 may be configured such that the lock member 36 is mounted by a relative movement in a direction other than the second direction Y1.

For example, the mounting portion 41 may suppress removal of the lock member 36 from the mounting portion 41 by using another configuration without the retaining convex portion 41d.

Moreover, for example, the mounting portion 41 may hold the lock member 36 at the third position P3 or the fourth position P4 by using another configuration without the position-keeping convex portion 41f.
In the foregoing embodiment, the retaining portion 36f and the position-keeping portion 36h are provided on the same third coupling portion 36d. The configuration is not limited thereto, and the retaining portion 36f and the position-keeping portion 36h may be provided on different coupling portions. For example, the lock member 36 may be configured with an additional fourth coupling portion that couples the pair of sliding portions 36a, the retaining portion 36f may be provided on the third coupling portion 36d, and the position-keeping portion 36h may be provided on the fourth coupling portion.
In the foregoing embodiment, the arm 35 has the locking protrusion 51 that is fit into the slit 33b so as to regulate a movement of the arm 35. The configuration is not limited thereto, and the locking protrusion 51 may be omitted.
In the foregoing embodiment, the plurality of arms 35 may be provided for the single connector 31, which has not been particularly mentioned. For example, the arms 35 may be provided on the front and back sides of the connector 31 along the third axis Z or laterally provided along the second axis Y. As a matter of course, the portion provided with the arm 35 needs to have configurations for the arm 35, for example, the slit 33b and the rotating shaft 33c. Moreover, the counterpart housing 23 surely needs to be provided with the engaged portions 25 corresponding to the arms 35.
In the foregoing embodiment, the plurality of lock members 36 may be provided for the single connector 31, which has not been particularly mentioned. For example, the lock members 36 may be provided on the front and back sides of the connector 31 along the third axis Z or laterally provided along the second axis Y. As a matter of course, the portion provided with the lock member 36 needs to have configurations for the lock member 36, for example, the mounting portion 41.
In the foregoing embodiment, the counterpart connector 21 includes the two counterpart terminals 22 and the connector 31 includes the two terminals 32. The number of counterpart terminals 22 and the number of terminals 32 may be changed to other numbers, e.g., one or three or more.
As illustrated in FIG. 4, in a state in which the lever 34 is located at the first position P1, the lever 34 may cover the overall lock member 36 when viewed in a direction along the third axis Z. As illustrated in FIG. 5, in a state in which the lever 34 is located at the second position P2, at least a half of the lock member 36 may be exposed from the lever 34 when viewed in the direction along the third axis Z.
As illustrated in FIG. 12, in a state in which the lever 34 is located at the first position P1, the regulating surface 34f that regulates a movement of the lock member 36 to the fourth position P4 may be shaped like a flat surface orthogonal to the second axis Y.
As illustrated in FIG. 3, when the lever 34 moves between the first position P1 and the second position P2, the lock member 36 does not need to come into contact with the arm 35 operating in synchronization with the lever 34. In other words, the moving range of the lock member 36 does not need to interfere with the moving range of the arm 35.
As illustrated in FIG. 8, the retaining portion 36f and the position-keeping portion 36h may be disposed in parallel along the first axis X. The convex portions 36e may be referred to as guide convex portions.
As illustrated in FIG. 5, if the lever 34 is moved to the first position P1 in a state in which the lever 34 is located at the second position P2 and the lock member 36 is located at the fourth position P4, the contact portion 34d of the lever 34 may press the lock member 36 in the first opposite direction X2, that is, a direction crossing the moving direction of the lock member 36.
As illustrated in FIG. 5, like the terminals 32 are electrically connected to the counterpart terminals 22, a state in which the connector housing 33 is fit onto the counterpart housing 23 may be referred to as a normal fit state. As illustrated in FIG. 4, the initial fit state may be a state in which the connector housing 33 is fit onto the counterpart housing 23 at a position shifted in the first opposite direction X2 from a position in the normal fit state.
As illustrated in FIG. 4, when the position of the lever 34 is held at the first position P1, the connector housing 33 is moved from the position of the initial fit state in the first direction X1 by the arm 35 coming into contact with the engaged portion 25. The movement of the connector housing 33, that is, the approach to the normal fit state may be regulated. In this way, the approach of the connector housing 33 from the initial fit state to the normal fit state is regulated when the lever 34 is held at the first position P1. This is because the rotation of the arm 35 in synchronization with sliding of the lever 34 is regulated by holding the position of the lever 34. The engaging portions 35b may include the slit 35d where the engaged portion 25 can be inserted. The slit 35d may be curved to cross the first axis X.
As illustrated in FIGS. 1 and 2, the lever 34 may be shaped like a cylinder surrounding the outer periphery of the connector housing 33. As illustrated in FIGS. 4 and 5, the lever 34 may be slidable with respect to the connector housing 33 along the first axis X. The lever 34 may be referred to as a slide lever.
The counterpart connector 21 may be referred to as a first connector, and the connector 31 may be referred to as a second connector. The counterpart terminal 22 may be referred to as a first terminal, and the terminal 32 may be referred to as a second terminal. The counterpart housing 23 may be referred to as a first connector housing, and the connector housing 33 may be referred to as a second connector housing.
The present disclosure includes the implementation examples below. The reference numerals of some of constituent elements in the exemplary embodiment are indicated in the implementation examples as a supplement to understanding, not as limitations. Some of matters described in the following implementation examples may be omitted, or some of matters described in the implementation examples may be selected or extracted in combination.

[Note 1] According to an aspect of the present disclosure, the connector housing (33) may be configured such that only one end of the connector housing (33) in the first direction (X1) can be fit onto the counterpart housing (23) in a state in which the lever (34) is located at the first position (P1), and
the connector housing (33) may be configured to approach a state of fit to the counterpart housing (23) as the lever (34) moves from the first position (P1) to the second position (P2) in a state in which only one end of the connector housing (33) in the first direction (X1) is fit onto the counterpart housing (23).

[Note 2] A connector (31) according to some aspects of the present disclosure may be a connector (31) that is moved in a first direction (X1) along a first axis (X) so as to be connected to a counterpart connector (21) including counterpart terminals (22) and a counterpart housing (23), the connector (31) including: terminals (32) connectable to the counterpart terminals (22); a connector housing (33) that accommodates the terminals (32), the connector housing (33) being allowed to be fit in a normal fit state in which the connector housing (33) is fit onto the counterpart housing (23) to electrically connect the terminals (32) to the counterpart terminals (22); a lever (34) that is mounted on the connector housing (33) and is slidable with respect to the connector housing (33) along the first axis (X) between a first position (P1) and a second position (P2) ahead of the first position (P1) in the first direction X1; and a lock member (36) that is mounted on the connector housing (33) and is movable relative to the connector housing (33) in the range from a third position (P3) to a fourth position (P4), wherein the connector housing (33) may be configured to be fit in an initial fit state in which the connector housing (33) is located at a position shifted from a position in the normal fit state with respect to the counterpart housing (23) in a first opposite direction (X2) opposite to the first direction (X1), in a state in which the lever (34) is located at the first position (P1), the connector housing (33) may be configured to be placed in the normal fit state by moving the lever (34) from the first position (P1) to the second position (P2) in the initial fit state, and the lock member (36) may regulate a movement of the lever (34) by making contact with the lever (34) at the second position (P2) in a state in which the lock member (36) is located at the fourth position (P4), and the lock member (36) may be covered with the lever (34) in a state in which the lever (34) is located at the first position (P1) or may be exposed from the lever (34) in a state in which the lever (34) is located at the second position (P2).

[Note 3] According to an aspect of the present disclosure, the connector housing (33) may be configured to regulate a shift from the initial fit state to the normal fit state when the lever (34) is held at the first position (P1).

[Note 4] According to an aspect of the present disclosure, an arm (35) to be coupled to the lever (34) may be provided so as to move in a direction different from the sliding direction of the lever (34) according to a slide of the lever (34), wherein the connector housing (33) may be configured such that when the lever (34) is held at the first position (P1), the arm (35) comes into contact with the engaged portion (25) of the counterpart housing (23) so as to regulate a shift from the initial fit state to the normal fit state.

[Note 5] According to an aspect of the present disclosure, the arm (35) may have engaging portions (35b) that can be engaged with the engaged portion (25), the engaging portions (35b) may include a slit (35d) where the engaged portion (25) can be inserted, and the slit (35d) may be curved to cross the first axis (X).

[Note 6] According to an aspect of the present disclosure, a movement of the lever (34) from the first position (P1) to the second position (P2) may be regulated in an unmated state in which the connector housing (33) is not fit onto the counterpart housing (23).

[Note 7] According to an aspect of the present disclosure, an arm (35) to be coupled to the lever (34) may be provided so as to move in a direction different from the sliding direction of the lever (34) according to a slide of the lever (34), the connector housing (33) may include a slit (33b) that extends along the first axis (X), the arm (35) may have a locking protrusion (51) that is fit into the slit (33b) so as to regulate a movement of the arm (35) in a state in which the lever (34) is located at the first position (P1), the lever (34) may have an elastic piece (52) that presses the arm (35) in a direction that fits the locking protrusion (51) into the slit (33b), and the locking protrusion (51) may be pressed out of the slit (33b) by an extruding portion (26) of the counterpart housing (23) in the initial fit state.

### LIST OF REFERENCE NUMERALS

11 connector assembly
21 counterpart connector
22 counterpart terminal
23 counterpart housing
23a wall portion
24 protruding extension
25 engaged portion
26 extruding portion
26a inclined face
31 connector
32 terminal
33 connector housing
33a wall portion
33b slit
33c rotating shaft
33d wall portion
33e rail portion
33f thick portion
33g step
33h inner wall surface
34 lever
34a concave portion
34b wall portion
34c coupled portion
34 contact portion
34e storage portion
34f regulating surface
34g slit
35 arm
35a central hole
35b engaging portion
35c extended portion
35d slit
35e coupling shaft
36 lock member
36a sliding portion
36b first coupling portion
36c second coupling portion
36d third coupling portion (coupling portion)
36e convex portion
36f retaining portion
36g inclined face
36h position-keeping portion
36j inclined face
36k inclined face
36m operation portion
36n lock portion
36p inclined portion
41 mounting portion
41a rail groove
41b terminal end portion
41c horizontal groove
41d retaining convex portion
41e inclined face
41f position-keeping convex portion
41g inclined face
41h inclined face
42 support portion
51 locking protrusion
51a locking face
51b first inclined face
51c second inclined face
52 elastic piece
52a pressing portion
52b third inclined face
P1 first position
P2 second position
P3 third position
P4 fourth position
P5 fifth position
P6 sixth position
WH wire harness
X first axis
X1 first direction
X2 first opposite direction
Y second axis
Y1 second direction
Y2 second opposite direction
Z third axis

1. A connector connectable to a counterpart connector by a relative movement in a first direction along a first axis, the counterpart connector including a counterpart terminal and a counterpart housing, the connector comprising:
a terminal connectable to the counterpart terminal;
a connector housing that accommodates the terminal and is allowed to be fit onto the counterpart housing;
a lever that is mounted on the connector housing and is movable relative to the connector housing along the first axis in a range from a first position to a second position ahead of the first position in the first direction; and
a lock member that is mounted on the connector housing and is movable relative to the connector housing in a range from a third position to a fourth position, wherein
the connector housing is configured to approach a state of fit to the counterpart housing as the lever moves from the first position to the second position,
the lock member regulates a movement of the lever by making contact with the lever located at the second position in a state in which the lock member is located at the fourth position, and the lock member is covered with the lever in a state in which the lever is located at the first position or is exposed from the lever in a state in which the lever is located at the second position.

2. The connector according to claim 1, further comprising an arm that is drivingly coupled to the lever and moves in a direction different from a moving direction of the lever according to a relative movement of the lever, wherein
the arm has an engaging portion that is allowed to be engaged with an engaged portion of the counterpart housing, and
the connector housing is configured to move relative to the counterpart housing and approach a state of fit to the counterpart housing as the engaging portion in engagement with the engaged portion moves according to a movement of the lever from the first position to the second position.

3. The connector according to claim 1, wherein the lock member is movable in a range from the third position to the fourth position along a second axis crossing the first axis.

4. The connector according to claim 3, wherein in a state in which the lever is located at the first position, a movement of the lock member from the third position to the fourth position is regulated by bringing the lock member into contact with the lever.

5. The connector according to claim 3, wherein the lever has a contact portion at an end of the lever on a side of a first opposite direction that is opposite to the first direction, and
the lock member regulates a movement of the lever by making contact with the contact portion of the lever located at the second position in a state in which the lock member is located at the fourth position.

6. The connector according to claim 3, wherein the connector housing includes a support portion capable of holding the lock member with the lever along the first axis in a state in which the lever is located at the second position and the lock member is located at the fourth position.

7. The connector according to claim 3, wherein the connector housing includes a mounting portion capable of mounting the lock member,
the mounting portion includes a pair of rail grooves extending along the second axis, and
the lock member includes a pair of sliding portions that are fit into the rail grooves and are slidable along the rail grooves and a coupling portion that couples the pair of sliding portions.

8. The connector according to claim 7, wherein the rail groove has a horizontal groove that is recessed in a direction crossing a recessing direction of the rail groove, and
the sliding portion has a convex portion to be fit into the horizontal groove.

9. The connector according to claim 8, wherein the lock member is mounted by a movement relative to the mounting portion in a second direction along the second axis,
the mounting portion has a retaining convex portion between the pair of rail grooves,
the coupling portion has a retaining portion that suppresses removal of the lock member from the mounting portion by engagement of the retaining portion with the retaining convex portion in a second opposite direction opposite to the second direction, and
the retaining portion is allowed to slide over the retaining convex portion as the coupling portion is deformed by a movement of the lock member relative to the mounting portion in the second direction.

10. The connector according to claim 9, wherein the mounting portion has a position-keeping convex portion between the pair of rail grooves,
the coupling portion has a position-keeping portion that suppresses a movement of the lock member from the third position to the fourth position and a movement of the lock member from the fourth position to the third position by engagement of the position-keeping portion with the position-keeping convex portion and holds the lock member at the third position or the fourth position, and
the position-keeping portion is allowed to slide over the position-keeping convex portion as the coupling portion is deformed by a movement of the lock member relative to the mounting portion along the second axis.

11. The connector according to claim 10, wherein the coupling portion having the retaining portion and the coupling portion having the position-keeping portion are the same.

12. A connector assembly comprising:
the connector according to claim 1, and
the counterpart connector.
